(19) United States
(12) Patent Application Publication
(10) Pub. No.: US 2019/0055070 A1
(43) Pub. Date: Feb. 21, 2019

(54) Tabbed Seal For Beverage Pod

(71) Applicant: Selig Sealing Products, Inc., Forrest, IL (US)

(72) Inventors: John J. Brown, LaGrange, IL (US); Rafael Zamora, Oberglatt (CH)

(21) Appl. No.: 15/998,855

(22) Filed: Aug. 17, 2018

Related U.S. Application Data
(60) Provisional application No. 62/546,732, filed on Aug. 17, 2017.

(51) Int. Cl. B65D 53/08; B65D 85/804; B65D 65/40; B32B 27/08; B32B 27/32; B32B 27/36; B32B 7/12

(52) U.S. Cl. CPC B65D 53/08; B65D 85/8046; B65D 65/40; B32B 27/08; B32B 2439/70; B32B 27/36; B32B 7/12; B32B 2435/02; B32B 27/32

(57) ABSTRACT

A beverage pod is provided that includes a body and a seal or lid. The seal may include a tab to assist the user in removing the seal or lid from the body. The body may be configured in any suitable shape to be used in a beverage preparation machine. Further, the body may contain a variety of different materials for beverage preparation. For example, the body may contain, powders, particles, liquids, extracts, and the like to be used to prepare a beverage.

### CROSS-REFERENCE TO RELATED APPLICATIONS

This application claims benefit of U.S. Provisional Application No. 62/546,732, filed Aug. 17, 2017.

### FIELD

The present application relates to beverage pods and, more specifically, to beverage pods having a lid or sealing member that includes a tab for removal of the sealing member after beverage preparation.

### BACKGROUND

Beverage pods, such as for coffee, tea, chocolate, and other beverages have been increasing in popularity with consumers as a quick way to prepare custom beverages. However, there has been increasing pushback from consumers and environmental agencies regarding the lack of an easy way to recycle the beverage pods and/or the remaining contents. Currently pods are put into standard trash and are simply adding to landfills.

In view of this, there in an increasing need to allow for beverage pods to be more easily recyclable, such as by permitting consumers to more easily disassemble the pods and/or remove any remaining contents. Typically, pods are produced whereby the seal or cover is punctured while preparing the beverage. However, due to the heat, moisture, and other conditions used during beverage preparation by the end user, the seal is attached in a manner to survive these conditions such that it is not easily removable. Further, during manufacture and assembly, the beverage pod may also be subjected to high heat and pressure applications, such as retort, hot filling, pasteurization, and the like. In this regard, the seal must be securely affixed such that it may be very difficult to remove, thereby the remaining contents of the pod are not easily removed for recycling. Oftentimes, the user must pierce the seal with his or her finger or a utensil to gain access to the interior of the pod. However, even when pierced in this manner, the sealing member may still be difficult to completely remove from the beverage pod such that the beverage pod may still not be suitable for recycling.

Therefore, there is a need for a beverage pod container that is more readily disassembled by the end user and recycled.

### SUMMARY

Various enhancements of tabbed seals are provided herein with enhanced grasping functionality. The below described embodiments may be used.

In one form, tabbed sealing members are provided for sealing beverage pods. The sealing members are configured such that they are suitable to provide an adequate seal during manufacture of the beverage pods as well as during beverage preparation by an end user. In some forms, the sealing member is suitable for withstanding manufacturing temperatures, pressures, vapors, and other conditions, including, but not limited to, retort, pasteurization, and the like. Furthermore, the sealing member is suitable for withstanding beverage preparation conditions such as heat, steam, pressure, and other conditions.

The sealing member also includes a tab on an upper surface thereof permitting a user to easily grasp the tab to remove the sealing member. The sealing member is configured such that the seal is readily removable by the user whereby a portion of the sealing member ruptures or tears to release at least a portion of the sealing member from the beverage pod. Once at least a portion of the sealing member is removed, a user can gain access to the remaining interior contents. The interior contents, the beverage pod body, and/or the sealing member ran then be recycled.

According to one form, a tabbed sealing member is provided for sealing to a rim surrounding a beverage pod opening. The tabbed seal includes a lower laminate having a plurality of layers, an upper portion having at least one layer, a sealant layer, a sacrificial layer, and a polymer layer. The upper portion is partially bonded to the lower laminate such that a free portion of the upper portion forms a tab. The upper portion is defined wholly within the perimeter of the sealing member. The sealant layer forms a lowermost layer of the lower laminate and is configured to adhere the tabbed sealing member to the beverage pod. The sacrificial layer is positioned in the lower laminate above the sealant layer. The sacrificial layer is configured to rupture or tear adjacent the perimeter of the sealing member. The polymer layer is positioned in the upper portion, at least a portion of the polymer layer forming a portion of the tab.

A beverage pod is also provided having the sealing member described above.

In accordance with one form, a laminate for forming a tabbed sealing member for sealing to a rim surrounding a beverage pod opening is provided. The laminate comprises a lower laminate having a plurality of layers, an upper portion having at least one layer, a sealant layer, a sacrificial layer, and a polymer layer. The upper portion is partially bonded to the lower laminate such that a free portion of the upper portion forms a tab when formed into the sealing member. The sealant layer forms a lowermost layer of the lower laminate and is configured to adhere the tabbed sealing member to the beverage pod. The sacrificial layer is positioned in the lower laminate above the sealant layer and is configured to rupture or tear. The polymer layer is positioned in the upper portion, at least a portion of the polymer layer forming a portion of the tab when formed into a sealing member.

### BRIEF DESCRIPTION OF THE DRAWINGS

FIG. 1 is a perspective view of a beverage pod having a tabbed sealing member;

FIG. 2 is a side view of a beverage pod with a tabbed sealing member;

FIG. 3 is a top view of a tab positioned across the center of the pod;

FIG. 4 is a top view of a tab biased off-center;

FIG. 5A is a cross-sectional view of one form of a tabbed sealing member;

FIG. 5B is a cross-sectional view of the sealing member of FIG. 5A with the tab lifted;

FIG. 6 is a cross-sectional view of another form of a sealing member with the tab pivoted upward;

FIG. 7 is a cross-sectional view of one form of a sealing member with a tab that extends only part way across the seal;

FIG. 8 is a cross-sectional view of another form of tabbed sealing member with a tab positioned towards an outer edge;

FIG. 9 is an exploded view of one form of a beverage pod with a sealing member having a sacrificial layer;

FIG. 10 is a top view of the beverage pod of FIG. 9 where the sealing member has been removed by a user after beverage preparation; and

FIG. 11 is a cross-sectional view of a sealing member wherein a sacrificial layer has ruptured leaving a remnant of the sacrificial layer and a sealant layer on a beverage pod rim.

### DETAILED DESCRIPTION

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

For simplicity, this disclosure generally may refer to a beverage pod, but the sealing members herein may be applied to any type of capsule, container, bottle, package or other apparatus having a rim or mouth surrounding an access opening to an internal cavity. In this disclosure, reference to upper and lower surfaces and layers of the components of the sealing member refers to an orientation of the components as generally depicted in the figures and when the sealing member is in use with a container in an upright position and having an opening at the top of the container. Different approaches to the sealing member will first be generally described, and then more specifics of the various constructions and materials will be explained thereafter.

The present disclosure generally relates to tabbed sealing members having a gripping tab defined wholly within a perimeter of the seal that is configured to provide a suitable seal for conditions used during manufacture of a beverage pod as well as the conditions used for preparation of a beverage by an end user. Further, the sealing member is configured such that the sealing member is readily removable by an end user after the beverage pod has been used to prepare a beverage, thus permitting at least a portion of the sealing member to be removed from the beverage pod and the remaining contents of the beverage pod to be removed, allowing the pod to be recycled.

As noted above, the beverage pod manufacturing process and beverage preparation process may each be relatively aggressive due to a number of factors including, but not limited to, heat, moisture, steam, pressure, and the like. For example, during manufacture of the beverage pod, it may be subject to retort, hot filling, pasteurization, and the like. Additionally, when used as a coffee pod, the pod may be subject to high heat, boiling water, as well as increased pressure. In some forms, the seal or lid of the pod may be pierced so as to introduce liquid to the contents during the beverage making process. In view of these factors, the beverage pod and seal/lid may be configured so as to withstand such processing conditions.

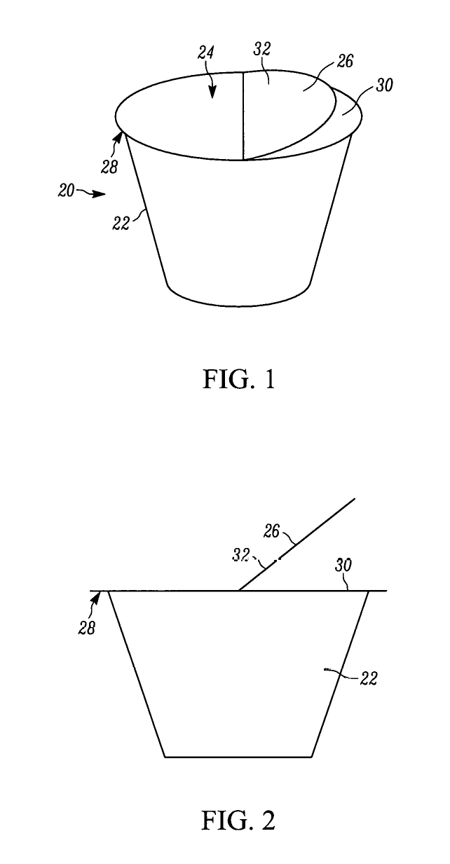

In one form, a beverage pod 20 is provided that includes a body 22 and a sealing member 24, such as shown in FIG. 1. The sealing member 24 may include a tab 26 to assist the user in removing the sealing member 24 from the body 22. The body 22 may be configured in any suitable shape to be used, such as in a beverage preparation machine. Further, the body 22 may include a variety of different contents for beverage preparation. For example, the body 22 may contain, powders, particles, liquids, extracts, and the like to be used to prepare a beverage.

The body 22 may take a variety of forms and be manufactured from a variety of different materials. For example, the body 22 may be manufactured from plastic, aluminum, and combinations thereof. In this form, the body may be made from materials that are readily recyclable, compostable, and/or otherwise more suitable for disposal. In one form, the body 22 includes polypropylene and/or other polymer materials.

The tabbed sealing member 24 is also made of a material such that it is still pierceable by the user's beverage machine during beverage preparation. In this regard, the user's machine includes a knife or other piercing structure to puncture one or more openings in the sealing member 24. The overall sealing member 24 and/or tab 26 must be configured and made of materials that still permit the machine to pierce the seal, yet be resilient enough to withstand pod manufacture and also beverage preparation. The sealing member 24 is generally bonded to a rim 28 of the body 22 whereby the rim 28 generally defines an opening 29 whereby beverage manufacturing contents may be placed inside the body 22.

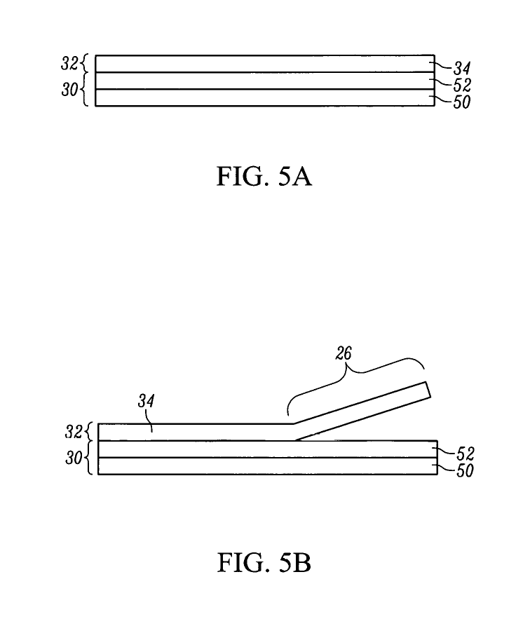

The sealing member 24 may be made from a variety of combinations of layers, depending on the body material, processing conditions, and the like. Generally, the sealing member 24 may include a lower laminate 30 and an upper portion 32 including at least one layer. As shown in FIG. 5A, the upper portion 32 includes a single layer, such as a polymer layer 34. In one form, the polymer layer 34 is a layer of polyethylene terephthalate (PET). However, it should be understood that the upper portion 32 may include multiple layers of the same and/or different material, as well as adhesives and the like. The polymer layer 34 may be formed from a variety of different materials. In one form, the tab may include one or more polymer layers, which may be a structural polymer layer such as polypropylene, polyester (PET), PEN, nylon, or the like. The thickness of polymer layer 34 and upper portion 32 may be varied, as desired.

The upper portion 32 is partially bonded to the lower laminate 30 such that a free portion of the upper portion 32 forms the tab 26. The tab 26 is readily lifted and graspable by a user. The upper portion 32 may be bonded to the lower laminate 30 by an adhesive layer such as a partial adhesive layer. Similarly, the upper portion 32 may also be bonded such as by heating one or more of the upper portion 32 and the lower laminate 30. The unbonded portion of the upper portion 32 that forms the tab 26 may also include a release layer to prevent the tab from adhering to the lower laminate 30.

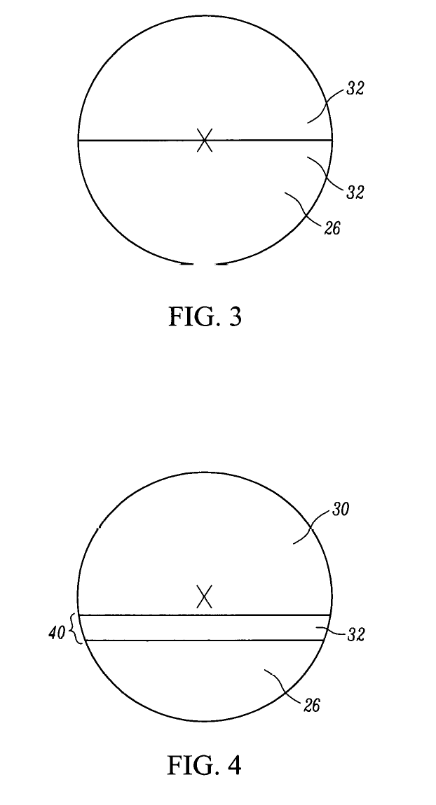

The tab 26 may be configured and positioned at various locations on the sealing member 24. In one aspect, the sealing member 24 includes the tab 26 defined wholly within a perimeter or circumference of the sealing member, such as shown in FIGS. 3 and 4. Further, according to one form, the tab 26 may be a half moon or similar shape such that the tab is easily graspable by the user, such as shown in FIG. 3. However, other shapes are also contemplated.

As shown in FIGS. 3, 5A, and 5B, the upper portion 32 extends the entire circumference of the sealing member 24. In other words, when the tab 26 is down, the upper portion 32 covers the entire top surface of the sealing member 24. When the tab 26 is lifted, a portion of the lower laminate 30 is then exposed, such as shown in FIG. 5B.

As shown in FIG. 3, the tab 26 may be positioned such that it is approximately half of the overall surface area of the sealing member 24, generally extending across the diameter of a circular seal. The center of the sealing member 24 is positioned at the “X.” In this form, the tab pivots about the center of the circular sealing member 24. In another form, such as shown in FIG. 4, the tab 26 may be positioned off-center. In this form, if the beverage machine is designed to puncture the central area of the sealing member 24, the tab 26 will not interfere and would otherwise not be damaged during beverage preparation. However, other locations on the seal are also contemplated.

In some forms, the upper portion 30 of the seal does not extend the full width of the sealing member 24 in order to define the gripping tab. For example, referring to FIG. 4, the upper portion 32 extends less than half of the overall surface area of the sealing member 24. In this form, at least a portion of the lower laminate 30 forms a top surface of the sealing member.

To this end, the tabbed sealing members herein may also combine the advantages of a tabbed sealing member with a large gripping tab defined completely within the perimeter of the seal, but achieve such functionality with less material (in view of the part layers of the upper portion) and permit such a tab structure to be formed on many different types of pre-formed lower laminates.

In further aspects of this disclosure, the sealing members 24 herein may include a pull or grip tab defined by the upper portion 32 wholly within a perimeter or circumference of the sealing member 24 wherein an upper surface of the sealing member is partially defined by the upper portion 32 and partially defined by the lower laminate 30, such as shown in FIG. 4. In one approach of this aspect, the top surface of the sealing member is provided by a minor portion of the upper portion 32 and a major portion of the lower laminate 30. In other approaches of this aspect, the lower laminate 30 is partially exposed at a top surface of the seal with about 50 percent to about 75 percent (or more) of the lower laminate 30 exposed at the top surface of the entire seal. The seals of this aspect allow consumers to remove the sealing member using the tab (as in a conventional pull tab seal) and/or puncture the sealing member by piercing the exposed lower laminate portion to provide push/pull functionality depending on the preference of the consumer.

A further example of this configuration is shown in FIG. 7 whereby the upper portion 32 includes the tab 26 that is not bonded to the lower laminate 30 and a smaller bonded portion 40. In this form, the tab 26 is much larger than the bonded portion 40. As noted above, this form may permit the beverage machine to avoid puncturing the upper portion 32.

Yet another form is shown in FIG. 8 whereby the tab 26 is located towards an outer edge of the sealing member. In this form, the tab 26 is formed from a separate layer 36 than the polymer layer 34. The separate layer 36 could be a different polymer layer, a tab stock material, or simply a different thickness than the polymer layer 34. Further, in one form, a release layer 38 may be provided to prevent the tab 26 from adhering to the lower laminate 30. An adhesive 39 may also be used, if necessary.

The sealing member 24 also includes a sealant layer 50 for maintaining the sealing member 24 on the body 22. The sealant layer 50 may be composed of any material suitable for bonding to the rim 28 of the body 22, such as but not limited to induction, conduction, or direct bonding methods. Suitable sealants, hot melt adhesives, or sealants for the adhesive layer include, but are not limited to, polyesters, polyolefins, ethylene vinyl acetate, ethylene-acrylic acid copolymers, surlyn, and other suitable materials. The sealant layer 50 may also take the form of a coated lacquer layer. By one approach, the sealant layer 50 may be a single layer or a multi-layer structure of such materials about 5 microns to about 120 microns thick. By some approaches, the sealant layer 50 is selected to have a composition similar to and/or include the same polymer type as the composition of the body 22.

For instance, if the body contains polyethylene, then the sealant layer 50 would also contain polyethylene. If the container contains polypropylene, then the heat seal layer would contain polypropylene. Other similar materials and combinations thereof may also be used. The adhesives useful for any of the optional adhesive layers described herein may include, for example, ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials.

According to one form, the sealant layer 50 should be selected so as to have a desirable heat resistance. As noted above, the beverage pod is oftentimes subject to manufacturing conditions, such as retort and pasteurizing, that involve heat, and other processing conditions. In this regard, in one form, the sealant layer 50 should be heat resistant to at least about 135° C. For example, the sealant layer 50 is capable of maintaining an adequate seal up to at least about 135° C. during the manufacturing process and/or during beverage preparation by an end user. Heat resistance can be impacted by a variety of factors such as the melting point of the outer layer of the heatseal film. In one form, the range for the melting point of the outer layer of the heatseal should be at least about 145° C.-165° C. It should be appreciated that other materials having a lower melting point could also be used so long as the layer provides a suitable seal at the desired temperatures.

Other suitable materials may include low density polyethylene, ethylene-acrylic acid copolymers and ethylene methacrylate copolymers. By one approach, any optional adhesive layers may be a coated polyolefin adhesive layer. If needed, such adhesive layers may be a coating of about 1 micron to about a 15 micron (or less) adhesive, such coated ethylene vinyl acetate (EVA), polyolefins, 2-component polyurethanes including aliphatic forms, ethylene acrylic acid copolymers, curable two-part urethane adhesives, epoxy adhesives, ethylene methacrylate copolymers and like bonding materials are also possible.

According to one form, one of the layers in the seal may be configured as a “sacrificial” layer. In this form, as the tab 26 is pulled, the layer may tear and/or separate from other layers in the seal. This layer may provide the user with an experience of the seal peeling from the body, even though the sealant used to bond to the body is very strong such that a portion of the sealant may remain on the body.

For example, the sealing member 24 may include a sacrificial layer 52 in the lower laminate 30 above the sealant layer 50. The sacrificial layer 52 may include materials and have an appropriate thickness to permit the layer to tear and/or separate from the other layers of the sealing member. In one form, the bond between the sealant layer 50 and the sacrificial layer is such that the bond survives the manufacturing process of the beverage pod, but when the tab 26 is pulled by a user, the bond releases. Similarly, the sacrificial layer 52 may rupture, such as adjacent the rim 28. In this form, the sacrificial layer 52 may simply tear at the portion of the layer just inside the rim 28.

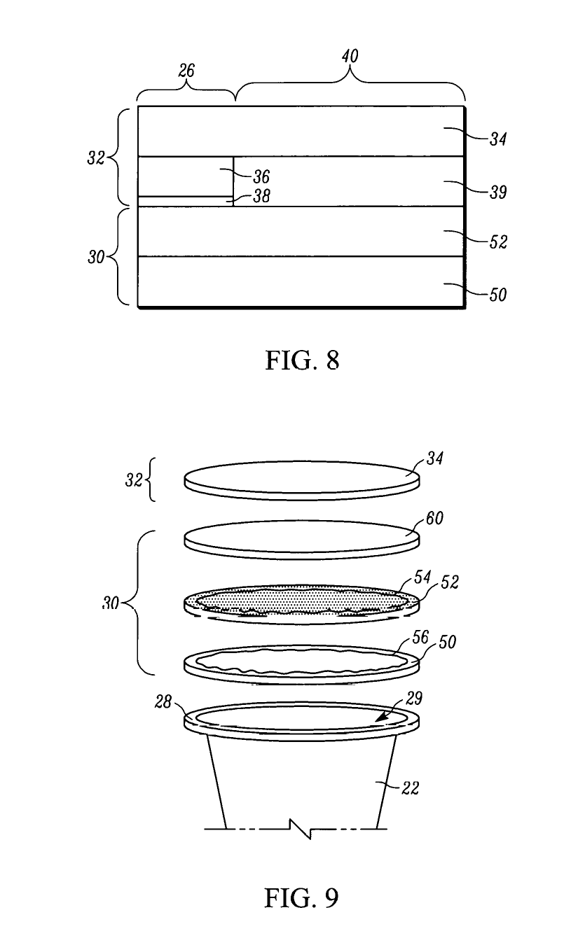

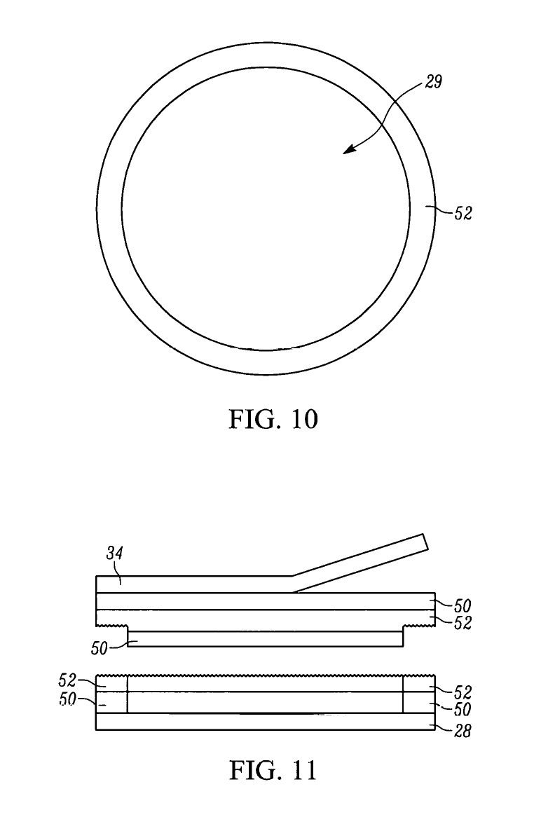

Various forms of the sealing member 24 including the sacrificial layer 52 are shown in FIGS. 9-11. An exploded view of one form is shown in FIG. 9. As shown in this figure, lines are shown which illustrate relative positions of rupture and/or tearing in the lower laminate 30. In this form, the sacrificial layer 52 will rupture and/or tear adjacent line 54 while the sealant layer 50 may also rupture and/or tear adjacent line 56. When a user pulls the tab 26, remnant portions of the sacrificial layer 52, along with a portion of sealant layer 50 will remain on the rim 28. As shown in FIG. 10, when viewed from above, a portion of sacrificial layer 52 can be seen still adhered to the rim 28.

As shown in FIG. 11, in one form, the sacrificial layer 52 ruptures internally such that a portion of the sacrificial layer 52 remains adhered to the rim 28 and a portion remains adhered to the upper portion 32. In this form, a majority of the sealant layer 50 and the sacrificial layer 52 positioned internally relative to the rim 28 will remain generally intact and coupled to the upper portion 30. In this form, when a user pulls on the tab 26 to remove the sealing member 24, substantially all of the entire sealing member 24 is removed that is positioned interior to the portion about the rim 28. Therefore, a user can easily access the interior contents of the body 22.

The sacrificial layer 52 can be made from a variety of different materials to provide the desired rupture and/or tearing characteristics. In one form, the sacrificial layer is EVA. However, other materials are also contemplated such as acrylate resins, polybutylene, ethylene methyl acrylates, and the like.

The sacrificial layer may also be configured such that it has a suitable thickness to tear and/or rupture. For example, depending on the material chosen for the sacrificial layer, it may have a thickness ranging from about 1 micron to about 20 microns. In one form, the sacrificial layer is EVA and has a thickness of about 5 microns.

In one form, the sacrificial layer 52 should have a rupture strength of at least about 1 N/15 mm. Alternatively, the sacrificial layer 52 should have a bond strength to the sealant layer 50 of at least about 1 N/15 mm to about 20 N/15 mm.

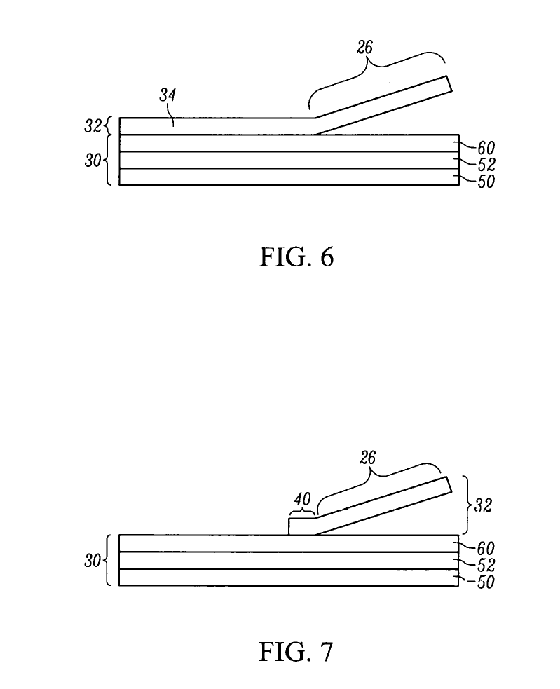

As shown in FIGS. 6-8, the sealing member 24 can include additional layers, such as additional layer 60. Additional layer 60 can be made from a variety of different material, such as polymer films, foams, and the like. The additional layer 60 can also be a membrane layer, such as a metal foil. It should be understood that a plurality of additional layers can be included and may comprise a variety of different materials. For example, the additional layers may include a polymer layer for support as well as a metal foil layer as a barrier layer and/or for use in induction sealing.

While the additional layer 60 is shown as part of the lower laminate 30, it should be understood that the additional layer 60 may also and/or alternatively be provided in the upper portion 32.

In one form, the additional layer 60 is a support layer comprising one or more polymer materials. The support layer can also include a coating to help provide barrier properties to the sealing member. For example, the additional layer 60 may be a polymer layer having at least one of a silicon oxide coating and an aluminum oxide coating. In this form, the additional layer may provide barrier properties relating to one or more of water vapor transmission and oxygen transmission.

Such coatings can be included to help provide the sealing member with a water vapor transmission rate of less than about 10 g/m² over 24 hours at 38° C. and 90% relative humidity and an oxygen transmission rate of less than about 150 cm³/m² over 24 hours at 23° C. and 0% relative humidity. In another form, the sealing member has a water vapor transmission rate of less than about 1 g/m² over 24 hours at 38° C. and 90% relative humidity and an oxygen transmission rate of less than about 1 cm³/m² over 24 hours at 23° C. and 0% relative humidity. Yet another form utilizes an additional layer 60 that is PET with an aluminum oxide coating that is angstroms thick and provides a water vapor transmission rate of less than about 0.3 g/m² over 24 hours at 38° C. and 90% relative humidity and an oxygen transmission rate of less than about 0.02 cm³/m² over 24 hours at 23° C. and 0% relative humidity.

It should be appreciated that, in some forms, the lower laminate and upper portion may include a variety of different layers and combinations of layers. For instance, the lower laminate may also include a membrane, such as a metal foil. In one form, the top surface of the lower laminate may be the metal foil. The lower seal portion may also include a foamed polymer or further polymer films, such as selected from polyolefin materials and polyester materials.

If included, the membrane layer may be one or more layers configured to provide induction heating and/or barrier characteristics to the seal. A layer configured to provide induction heating is any layer capable of generating heat upon being exposed to an induction current where eddy currents in the layer generate heat. By one approach, the membrane layer may be a metal layer, such as, aluminum foil, tin, and the like. In other approaches, the membrane layer may be a polymer layer in combination with an induction heating layer.

The membrane layer may also be or include an atmospheric barrier layer capable of retarding the migration of gases and moisture at least from outside to inside a sealed container and, in some cases, also provide induction heating at the same time. Thus, the membrane layer may be one or more layers configured to provide such functionalities. By one approach, the membrane layer is about 0.3 to about 2 mils of a metal foil, such as aluminum foil, which is capable of providing induction heating and to function as an atmospheric barrier.

Additional layers may be included in the upper portion and/or lower laminate such as polyethylene terephthalate (PET), nylon, or other structural polymer layers and may be, in some approaches, about 10 microns to about 250 microns thick. In some approaches, additional layers may be included in the lower laminate. It should be appreciated that the lower laminate may include any number of other layers, such as polymer layers, adhesives, polymer films, polymer foams, metal foils, and the like.

In some approaches, a non-foam heat distributing or heat redistributing layer may be included. In such approach, the non-foam heat distributing film layer is a blend of polyolefin materials, such as a blend of one or more high density polyolefin components combined with one or more lower density polyolefin components. Suitable polymers include but are not limited to, polyethylene, polypropylene, ethylene-propylene copolymers, blends thereof as well as copolymers or blends with higher alpha-olefins. By one approach, the non-foam heat distributing polyolefin film layer is a blend of about 50 to about 70 percent of one or more high density polyolefin materials with the remainder being one or more lower density polyolefin materials. The blend is selected to achieve effective densities to provide both heat sealing to the container as well as separation of the liner from the seal in one piece.

Further, polyolefin materials may be used as one or more of the other layers in the seal, such as one or more high density polyolefin components combined with one or more lower density polyolefin components, medium density components, and blends thereof. Suitable polymers include but are not limited to, polyethylene, polypropylene, ethylene-propylene copolymers, blends thereof, as well as copolymers or blends with higher alpha-olefins.

Further adhesives may be useful as adhesives or tie layers between the various layers described herein. Such materials may include, for example, ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials. Other suitable materials may include low density polyethylene, ethylene-acrylic acid copolymers, and ethylene methacrylate copolymers. By one approach, optional adhesive layers may be a coated polyolefin adhesive layer. If needed, such adhesive layers may be a coating of about 1 micron to about a 15 micron (or less) adhesive, such as coated ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials.

It should be appreciated that the body and seal may be suitable for use in a retort process during manufacture. Further, even though the seal is suitable for retort, it is still removable from the body, such as by using a sacrificial layer. Therefore, the seal may be removed from the body such that any remaining contents in the body can be removed and then one or more of the body and seal can be recycled, composted, and the like.

### Examples

In one example, the seal is a 30 micron to 150 micron coextruded film. The seal may include medium density polyethylene, EVA, and polypropylene. The polypropylene may be used to provide a sufficient weld or seal to a polypropylene body. The EVA layer may function as a sacrificial layer, as described above.

A further exemplary form of a seal may include a lower polypropylene layer, so as to be compatible with a polypropylene body. The seal may also include polyethylene terephthalate as part of the upper portion with a resin layer bonding to the lower laminate.

In yet another form, the sealant layer and sacrificial layer is a polypropylene coextruded film with medium density polypropylene, EVA, and polypropylene. The overall combination is approximately 40 microns. The last polypropylene layer, which generally functions as the sealant layer in the overall coextruded film, is approximately 5 microns.

In one form, the upper portion is PET, either plain, or SiOx coated, or AlOx coated, and has a thickness of approximately 12 microns. The adhesive used can be a polyurethane adhesive compliant for high temperature applications with a coating of 3-4.5 g/m2.

In other forms, the sealing member can be considered as duplex and triplex forms, similar to those found in the figures.

For a foil free version, a duplex option could include PET (12-36 microns) as the upper portion/sacrificial layer (2 gsm-6 gsm)/sealant layer (40-100 microns). The 12 micron PET can be plain or SiOx coated or AlOx coated. In one form, the lower laminate includes a coextruded material that is polyethylene (PE)/EVA/polypropylene (PP). Other examples may include PP/EVA/PP.

In triplex form, the sealing member may include PET (12-36 microns)/Adhesive (2 gsm-6 gsm)/PET (12-36 microns) as a support layer in the lower laminate/sacrificial layer (2 gsm-6 gsm)/sealant layer (40-100 microns). One of the two PET's can be plain or SiOx coated or AlOx coated. In one form, the sacrificial layer includes at least one of a 1 part or two-part polyurethane adhesive, acrylic adhesives, and the like. The sealant layer may take the form of a coextruded film, such as PE/EVA/PP, PP/EVA/PP, and the like.

The sealing member may also include a membrane layer, such as a metal foil layer. This can include a triplex version: PET (12-36 microns)/Adhesive (2 gsm-6 gsm)/Foil (6-30 microns)/sacrificial layer/sealant layer (40-100 microns).

PET is especially suitable for use in the upper portion as it is heat resistant and stiff enough to be pierced. A PP sealant layer is the most suitable for PP-Capsules.

The various layers of the sealing member are assembled via coating adhesives, applying films, and/or a heat lamination process forming a sheet or roll of the described layers. Extrusion lamination may also be used. The resulting laminate sheet or roll of the sealing members can be cut into appropriate sized disks or other shapes as needed to form a vessel closing assembly or tabbed sealing member. The cut sealing members can then be applied to the beverage pod or body and then secured thereto. This can be done by conduction sealing, induction healing, ultrasonic welding, as well as other forms of sealing.

It will be understood that various changes in the details, materials, and arrangements of the process, liner, seal, and combinations thereof, which have been herein described and illustrated in order to explain the nature of the products and methods may be made by those skilled in the art within the principle and scope of the embodied product as expressed in the appended claims. For example, the seals may include other layers within the laminate and between the various layers shown and described as needed for a particular application. Adhesive layers not shown in the Figures may also be used, if needed, to secure various layers together. Unless otherwise stated herein, all parts and percentages are by weight.

What is claimed is:

1. A tabbed sealing member for sealing to a rim surrounding a beverage pod opening, the tabbed seal comprising:
a lower laminate having a plurality of layers;
an upper portion having at least one layer, the upper portion being partially bonded to the lower laminate such that a free portion of the upper portion forms a tab, the upper portion defined wholly within the perimeter of the sealing member;
a sealant layer forming a lowermost layer of the lower laminate and configured to adhere the tabbed sealing member to the beverage pod;
a sacrificial layer positioned in the lower laminate above the sealant layer, the sacrificial layer configured to rupture or tear adjacent the perimeter of the sealing member; and
a polymer layer positioned in the upper portion, at least a portion of the polymer layer forming a portion of the tab.

2. The sealing member of claim 1 wherein the sealant layer is heat resistant up to about 135° C. or has a melting point of at least about 145° C.

3. The sealing member of claim 1 wherein the upper portion extends across an entire upper surface area of the seal.

4. The sealing member of claim 1 wherein the upper portion extends across less than the entire upper surface area of the seal.

5. The sealing member of claim 4 wherein the upper portion is positioned offset from a center point of the upper surface area of the seal such that the tab forms less than 50% of an upper surface area of the sealing member.

6. The sealing member of claim 1 wherein the sacrificial layer is ethylene vinyl acetate.

7. The sealing member of claim 1 wherein the sacrificial layer has a thickness of less than about 10 microns.

8. The sealing member of claim 1 wherein the sealant layer is selected from the group consisting of ethylene vinyl acetate, polyolefins, 2-component polyurethanes, ethylene acrylic acid copolymers, curable two-part urethane adhesives, epoxy adhesives, ethylene methacrylate copolymers, and combinations thereof.

9. The sealing member of claim 1 further comprising a foil layer in at least one of the lower laminate and the upper portion.

10. The sealing member of claim 1 wherein the lower laminate includes a polymer layer having at least one of a silicon oxide coating and an aluminum oxide coating.

11. The sealing member of claim 1 wherein the sealing member has a water vapor transmission rate of less than about 10 g/m² over 24 hours at 38° C. and 90% relative humidity and an oxygen transmission rate of less than about 150 cm³/m² over 24 hours at 23° C. and 0% relative humidity.

12. A beverage pod comprising:
a body having an interior chamber for containing a beverage material, the body including a rim defining an opening to the interior chamber; and
a sealing member, the sealing member including a lower laminate having a plurality of layers, an upper portion having at least one layer, the upper portion being partially bonded to the lower laminate such that a free portion of the upper portion forms a tab, the upper portion defined wholly within the perimeter of the sealing member, a sealant layer forming a lowermost layer of the lower laminate and configured to adhere the tabbed sealing member to the rim, a sacrificial layer positioned in the lower laminate above the sealant layer, the sacrificial layer configured to rupture or tear adjacent the perimeter of the sealing member, and a polymer layer positioned in the upper portion, at least a portion of the polymer layer forming a portion of the tab.

13. The beverage pod of claim 12 wherein the body comprises polypropylene and the sealant layer comprises polypropylene.

14. The beverage pod of claim 12 wherein the sealant layer is heat resistant up to about 135° C. or has a melting point of at least about 145° C.

15. The beverage pod of claim 12 wherein the upper portion extends across an entire upper surface area of the seal.

16. The beverage pod of claim 12 wherein the upper portion extends across less than the entire upper surface area of the seal and is positioned offset from a center point of the upper surface area of the seal such that the tab forms less than 50% of an upper surface area of the sealing member.

17. The beverage pod of claim 12 wherein the sacrificial layer is ethylene vinyl acetate and has a thickness of less than about 10 microns.

18. The beverage pod of claim 12 wherein the sealant layer is selected from the group consisting of ethylene vinyl acetate, polyolefins, 2-component polyurethanes, ethylene acrylic acid copolymers, curable two-part urethane adhesives, epoxy adhesives, ethylene methacrylate copolymers, and combinations thereof.

19. The beverage pod of claim 12 wherein the lower laminate includes a polymer layer having at least one of a silicon oxide coating and an aluminum oxide coating.

20. The beverage pod of claim 12 wherein the sealing member has a water vapor transmission rate of less than about 10 g/m² over 24 hours at 38° C. and 90% relative humidity and an oxygen transmission rate of less than about 150 cm³/m² over 24 hours at 23° C. and 0% relative humidity.

21. A laminate for forming a tabbed sealing member for sealing to a rim surrounding a beverage pod opening, the laminate comprising:
a lower laminate having a plurality of layers;
an upper portion having at least one layer, the upper portion being partially bonded to the lower laminate such that a free portion of the upper portion forms a tab when formed into the sealing member;
a sealant layer forming a lowermost layer of the lower laminate and configured to adhere the tabbed sealing member to the beverage pod;
a sacrificial layer positioned in the lower laminate above the sealant layer, the sacrificial layer configured to rupture or tear; and
a polymer layer positioned in the upper portion, at least a portion of the polymer layer forming a portion of the tab when formed into a sealing member.
